(19) United States
(12) Patent Application Publication
(10) Pub. No.: US 2010/0064282 A1
(43) Pub. Date: Mar. 11, 2010

(54) DECLARATIVE TESTING FOR USER INTERFACES

(75) Inventors: Edward J. Triou, Duvall, WA (US); Zafar Abbas, Woodinville, WA (US); Sravani Kothapalle, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/204,916

(22) Filed: Sep. 5, 2008

(51) Int. Cl. G06F 9/44

(52) U.S. Cl. 717/125; 717/124

(57) ABSTRACT

The claimed matter provides systems and/or methods that actuate and/or facilitate declarative testing of software applications. The system can include devices that receive or elicit declarative definitions of testing scenarios and employs the declarative definitions to test a software application under consideration. Further, the system also compares the supplied declarative definitions with the results obtained from execution of the declarative definition. Where dissimilarity is observed the differences are persisted and the differences so persisted utilized as subsequent declarative definitions in order to iterate to a goal set forth in the declarative definition. In particular, the claimed matter can commence with a declarative answer, focus on a multiplicity of possible scenarios rather than the numerous operations needed to attain these scenarios, and utilize the differences obtained from execution of the declarative answer in order to simplify verification of software products.

### BACKGROUND

Software or application user interface testing can be an extremely challenging problem as there can be a multiplicity of controls, buttons, richness editors, designers, forms, and the like, change in any of which can have unintended knock on consequences in the testing of the software or application user interface. Moreover, today user interfaces are evolving and providing unprecedented interactive experiences through rich controls, such as, canvases, modeling designers, layering, rendering, etc. which in turn can make testing such interfaces even more challenging To date, best practices currently employed in the software or application testing industry have been utilization of recorders and/or automation that allow software or application testers to actually perform pre-established and enumerated sequences of actions involved in a testing scenario through utilization of the software or application user interface at issue, where the recorder and/or automated tool monitors everything that is done and captures every action performed by the tester so that the test case effectively becomes a playback of all the captioned actions.

Testing user interfaces today generally falls into one of two categories; manual and/or automated. Manual testing generally is the leveraging of people to use and/or abuse the application as a customer would, identifying issues associated with such use and/or abuse, and repeating the test process for each and every product fix necessitated by the testing. Manual testing, as will be readily appreciated, can be painfully tedious, laborious and prohibitively expensive due to the fact that manual testing can generally only be scaled by adding more people thereby raising the cost of testing through increased salaries. Automated testing on the other hand comprises the leveraging of software tools or applications to programmatically manipulate application or software user interfaces. Automated testing is currently one of the preferred approaches for a majority of software or application developers and vendors.

Nevertheless despite the popularity of automated testing within the software and/or application development community, there are a plethora of unsolved problems that plague automated testing. For instance, verifying the user interface can be costly and complex. For example, trying to verify a user interface that has been tested via automated testing can require the writing of complex software abstractions to track much of what the automated testing did as it proceeded through the user interface. It has been said that the coding of such complex software abstractions tends to be very similar or even more complex than the product under test (e.g., many in the field refer to this as a re-implementing the product code).

Moreover, testing has become more focused on automation to the detriment of focusing on real world or customer scenarios. For instance, most application and/or software development teams are now realizing that they are spending a significant amount of time on automation, leaving less and less time for writing/designing customer scenarios that utilize the product. In particular, development teams are coming to the realization that if they had just spent the same amount of time using the product (e.g., manually) as they had spent on engineering the complex software abstractions necessary to test the product, they would ultimately have had a higher quality end product.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The disclosed and described matter, in accordance with one or more various aspects, provides systems and methods that apply to software or application testing in general, and to the testing of software or application user interfaces in particular. More specifically, the claimed subject matter in accordance with an aspect provides systems and methods that effectuate declarative testing of a software application wherein the system provides an interface that can receive declarative definitions of testing scenarios (e.g., what the end result should be) and an executor that employs the declaratively defined testing scenarios to exhaustively test the software application. The system also includes a differential or differences aspect that provides a comparison between the received testing scenario declaratively defined (e.g., also referred to as the “answer”) and the result of the exhaustive test of the software application as performed by the executor or execution component. Where the differential or differences component determines that the comparative definition of the testing scenario (e.g., the “answer”) and the result of the exhaustive test of the software application (e.g., the product of the executor component) are dissimilar, the differential or differences component persists the difference to a storage component as an answer diff, the persisted answer diff can be utilized thereafter for further tests on the software application. It should be noted without limitation or lack of generality that the differential or differences component can be utilized both for purposes of verification as well as to perform incremental execution of the software product. Moreover, in the context of verification the answer diff between the actual product state and the declared answer (e.g., the declaratively defined testing scenario) can be compared to verify the testing scenario. In contrast, in the context of incremental execution of the software product, the answer diff between an old answer state and the new answer can be utilized to make further progress in the test execution scenario.

Additionally, the disclosed and described subject matter in accordance with a further aspect can include an incremental feature that facilitates and/or effectuates incremental execution of the software product through utilization of declaratively defined testing scenarios and/or subsequent declarative answers, whereby the executor and/or the differential or differences aspects can actuate the incremental acts required for the product to attain a state defined by a particular subsequent declarative answer. More succinctly, where the claimed matter, for the purposes of verification, for example, identifies differences between the received testing scenarios declaratively defined and the results of exhaustive tests on the software product can leverage such differences by executing the identified differences.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that facilitates and/or effectuates declarative testing of software applications and/or software application interfaces in accordance with aspects of the claimed subject matter.

FIG. 2 provides a more detailed depiction of an illustrative testing component that facilitates and/or effectuates declarative testing of software applications and/or software application interfaces in accordance with an aspect of the claimed subject matter.

FIG. 3 provides a more detailed depiction of an illustrative executor component that effectuates declarative testing of software applications and/or software application interfaces in accordance with an aspect of the claimed subject matter.

FIG. 4 provides a more detailed depiction of an illustrative differential component that facilitates and/or effectuates declarative testing of software applications and/or software application interfaces in accordance with an aspect of the claimed subject matter.

FIG. 5 provides partial depiction of a user interface designer in accordance with an aspect of the claimed subject matter.

FIG. 6 provides a generalized but illustrative schematic overview of actuation of the claimed matter.

FIG. 7 illustrates yet another generalized but illustrative schematic overview of the claimed matter in the context of numerous execution paths.

FIG. 8 depicts an illustrative flow diagram of a machine implemented methodology that facilitates and/or effectuates declarative testing of software applications and/or software application interfaces in accordance with aspects of the claimed subject matter.

FIG. 9 illustrates a block diagram of a computer operable to execute the disclosed system in accordance with an aspect of the claimed subject matter.

FIG. 10 illustrates a schematic block diagram of an illustrative computing environment for processing the disclosed architecture in accordance with another aspect.

FIG. 11 provides an illustrative aid to understanding the distinction between a declaratively defined scenario and a scenario imperatively outlined.

FIG. 12 provides a state diagram that outlines incremental execution of the claimed matter wherein a first answer is utilized as input to generate a second answer which can subsequently employed to generate further answers each in turn being utilized to incrementally iterate to the initial supplied answer.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

Given the proliferation of user interfaces (e.g., graphical user interfaces) in today's software (e.g., video games, business applications, productivity software, operating systems, . . . ), coupled with the daunting task of verifying them, there is no shortage of existing user interface testing tools. Many of the testing tools provide great value, adding automation application programming interfaces (APIs) for user interface testing, or adding abstraction layers to reduce lines of code required. As good as many of them are they nevertheless do not solve two fundamental problems, namely, the focus is fixated on automation instead of testing scenarios, and verification is either ignored completely or is much too complex.

Further, existing user interface testing tools tend to fall into two camps: visual recorders/playback devices and/or programmatic user interface automation application programming interfaces (APIs). Visual recorders is slowly fading out of the testing discipline since they are rigid (e.g., regression) scripts of what a person manually does through a single path through the user interface. Visual recorders can be costly as they typically require human usage, are basically regression coverage (e.g., fixed capture), and generally only cover one explicit path for a particular operation. In user interfaces today, there typically can be numerous paths to do the same operations coupled with numerous views and contexts of the data. As will be appreciated traversing through these numerous paths coupled with the numerous views and contexts of data can require an exceedingly large number of recordings for every similar scenario, and further as would be expected is commensurately expensive and is too rigid. Moreover, recorders tend to offer little in terms of verification, other than ensuring that the script succeeded through the user interface, they tend to disclose nothing about the correctness of the current user interface presented to the user.

As for automation of application programming interfaces (APIs)—the current trend—there currently are numerous versions of such application programming interfaces (APIs) that involve user interface automation (e.g., accessibility aids that can include screen readers, visual indicators, software to compensate for motor disabilities, etc.). Such facilities continue to improve the abstraction of the user interface (e.g., logical) primitives, each continues to reduce the lines of code required for automating (e.g., buttons, forms check boxes, trees, context menus, etc.). While these application programming interfaces (APIs) are much-needed and the refinements they have brought forth have produced incredible gains, these interfaces have not redirected the focus away from the fixation on automation to a more directed and singular focus on the richness of user scenarios.

As for verification, little has improved or been provided by or from the application programming interfaces (APIs) themselves. Most development teams take these basic application programming interfaces (APIs) and abstract and append their own specific application programming interfaces (APIs) on top (e.g., as wrappers) in order to track (or compute) the state of everything that is called against the application programming interface (API). While this approach generally improves the amount of verification that was traditionally performed such an approach unfortunately does not provide any reduction in the complexity of verification. In fact the approach actually tends to make the situation worse since so many more states need to be verified than was traditionally the case.

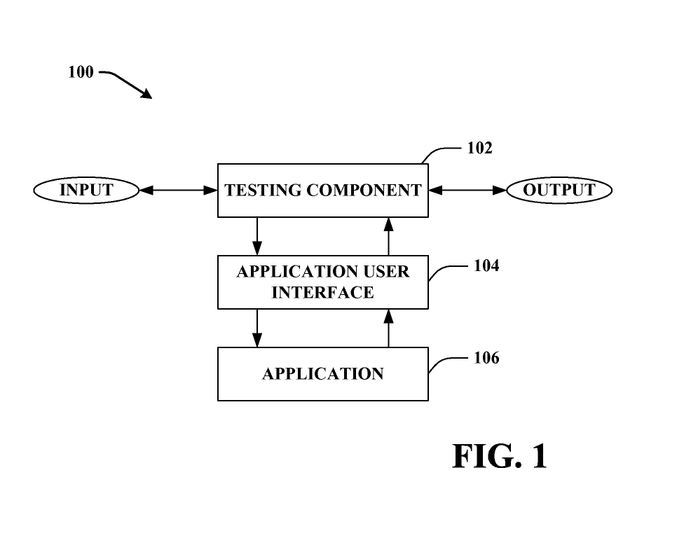

FIG. 1 illustrates a machine-implemented system 100 that facilitates and/or effectuates declarative testing of software applications and/or software application interfaces in accordance with various aspects of the claimed subject matter. As depicted system 100 can include testing component 102 that can orchestrate automatically, dynamically, and/or programmatically a testing regimen that manipulates an application (e.g., application 106) via its application user interface (e.g., application user interface 104). Accordingly and as depicted, testing component 102 can be in continuous and/or operative or sporadic and/or intermittent communication with application 106 via application user interface 104. Moreover, testing component 102 be implemented entirely in hardware and/or a combination of hardware and/or software in execution. Further, testing component 102 can be incorporated within and/or associated with other compatible components. Additionally, testing component 102 can be, but is not limited to, any type of machine that includes a processor and is capable of effective communication with a network topology. Illustrative machines that can comprise testing component 102 can include desktop computers, server class computing devices, cell phones, smart phones, laptop computers, notebook computers, Tablet PCs, consumer and/or industrial devices and/or appliances, hand-held devices, personal digital assistants, multimedia Internet mobile phones and/or devices, multimedia players, and the like.

With regard to network topologies (not shown) with which testing component 102 can establish intercommunication and interchange, such topologies can include, but are not limited to, any viable communication and/or broadcast technology, for example, wired and/or wireless modalities and/or technologies can be utilized to effectuate the claimed subject matter. Moreover, the network topology can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, the network topology can include or encompass communications or interchange utilizing Near-Field Communications (NFC) and/or communications utilizing electrical conductance through the human skin, for example.

Additionally, testing component 102 can receive inputs such as declaratively defined testing scenarios that can be utilized by testing component 102 to exercise and/or manipulate application 106 through application user interface 104, and thereafter output verification of whether or not the testing scenario at issue completed and/or comported with the declaratively defined outcome suggested in the input testing scenario.

Application user interface 104 can provide facilities and/or functionalities that allow users to control and assess the state of application 106. Application user interface 104 typically can provide means for users to manipulate, use and/or abuse, application 106 in one or more various ways in order to accomplish items of work product (e.g., an aspect of a computer based video game). For instance, application 106 (e.g., a computer aided design application) can be developed to aid users in drafting parts and/or products ranging from utilitarian packaging (e.g., egg cartons) to complex avionics and aviation systems (e.g., wing spars, stabilizers, wiring conduits, and the like). Such an application (e.g., application 106), as will be appreciated by those of ordinary skill in the art, can have associated thereto multiple buttons, control interfaces, forms, and the like, each of which can be utilized to control and modify various aspects of the underlying application, and further modification of each of which can unexpectedly impinge on and/or effect (sometimes deleteriously) the functionalities and actions of the underlying application and interfere with the functionalities of other control interfaces, buttons, etc. Accordingly, in order to mitigate and/or avoid such unexpected consequences application interface user 104 together with application 106 needs to be extensively tested by testing component 102 prior to the release for public use and consumption of application 106.

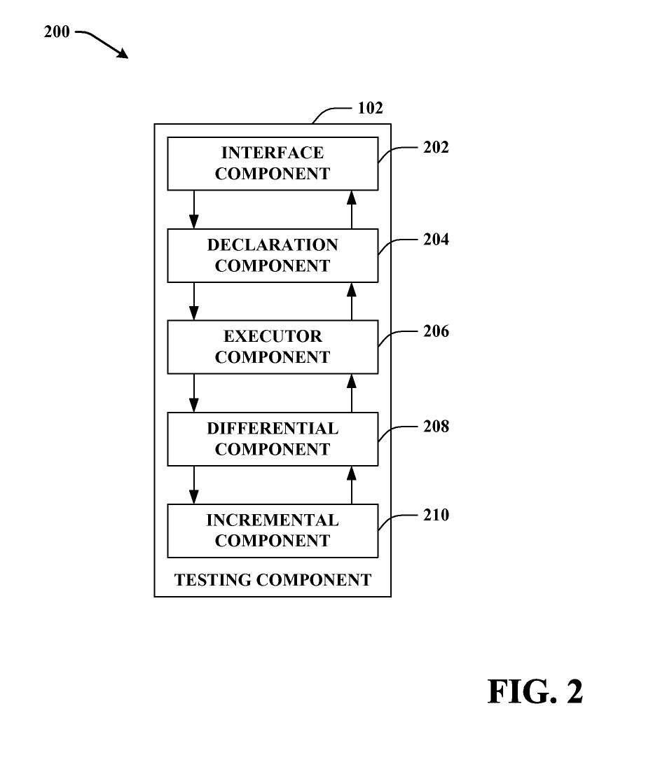

FIG. 2 provides further depiction 200 of testing component 102 in accordance with an aspect of the claimed matter. As illustrated testing component 102 can include any suitable and/or necessary interface component 202 (herein referred to as “interface 202”), that can provide various adapters, connectors, channels, communication pathways and/or modalities, etc. to integrate testing component 102 into virtually any operating and/or database system(s) and/or with one another. Additionally, interface component 202 can provide various adapters, connectors, channels, communication pathways and/or methodologies, etc. to effectuate and facilitate interaction or intercommunication with and between testing component 102 with application 106 via application user interface 104 (e.g., an application user interface that can provide interaction between users and the application), and/or any other component, data, and the like associated with the overall system 100, and/or system 200 in particular.

Additionally, testing component 102 can include declaration component 204 that can elicit declaratively defined testing scenarios from one or more input sources (e.g., data bases, from user (application programmer) input, feedback loops, and the like). By ensuring that test scenarios are defined declaratively, declaration component 204 forces the test scenario (or more particularly, the test scenario author) to focus on what needs to be achieved rather than on the minutiae and intricacies involved in how the end result should be achieved (e.g., an imperatively outline). By focusing on what ends needs to be achieved the test scenario author, for instance, can focus on the purpose of the scenario (e.g., this can be referred to as “starting with the answer”) rather than on the hundreds or thousands of operations that can be necessary to attain the end result of the scenario. More succinctly put, the premise is the answer and the declarative form is a representation of the answer. It should be noted that merely encapsulating imperative operations in a declarative manner does not generally imply the encapsulation of the answer (or purpose) as such encapsulation would still be imperative in nature as it does not elucidate the answer (or purpose) but rather sets forth the acts (or the declarative sequence) needed to reach the answer.

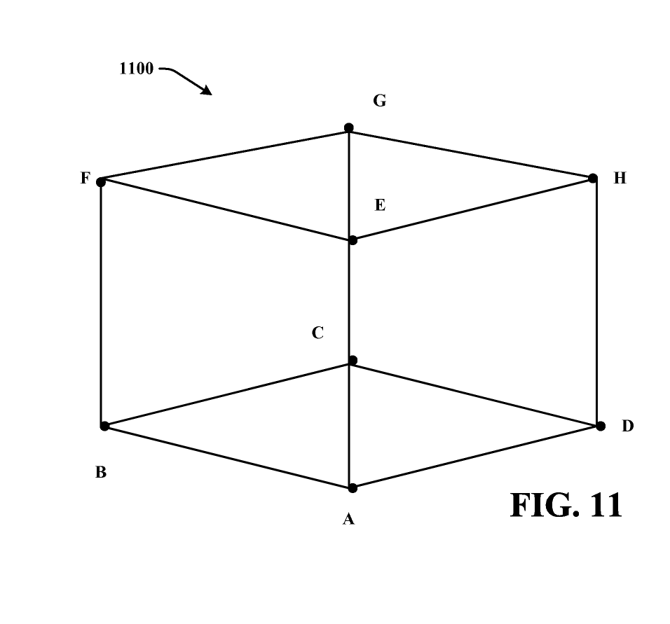

To provide illustration of the distinction between a declaratively defined scenario and a scenario imperatively outlined consider in conjunction with FIG. 11 an instance where a user wishes to draw an isometrically projected cube 1100 with vertices A, B, C, D, E, F, G, and H. Under an imperatively outlined scenario the user would enumerate the sequence of steps need to join the vertices to form the cube (e.g., connect A to B, D, and E, connect B to C and F, connect C to D and G, connect D to H, connect E to F, connect F to H, connect F to G, and connect G to H, ensure that the line segments between A and B and A and E form an angle of 60°, etc.). In contrast a declarative definition of the same cube isometrically projected could be: here are 8 vertices A, B, C, D, E, F, G, and H, connect them to form an isometrically projected cube. Alternatively and to state foregoing more simply and briefly, the declarative definition of the isometrically projected cube could just be “construct an isometrically projected cube”, as the naming of the vertices is not generally necessary to capture the purpose of the scenario. As will be observed, the declarative definition is extremely succinct. In a similar fashion by focusing on what needs to be achieved in exercising or manipulating the application 106 through its associated application user interface 104, declaration component 204 is causing focus on the purpose of the scenario rather than the hundreds of details necessary to achieve the scenario.

It should be noted without limitation, that a test scenario involving application 106 and its associated application user interface 104 typically envisions a more detailed comprehensive test typically used in a customer scenario (e.g., bring up an application, designing a set of C Sharp classes using the application, determining whether the newly designed set of classes work, and proving or verifying that the newly designed set of classes actually work). Moreover, the application or software testing context is typically one of those anomalous environments where one knows exactly what the test needs to do (e.g., answer), but then in testing the application or software one proceeds as if one did not have any awareness of the end result that needed to be achieved (e.g., define scenarios in terms of hundreds operations and tracking states as one randomly meanders through the application or software in order to later verify that the meandering reached the stated goal). Thus, by outlining the goal or answer that needs to be attained, verification of the goal or answer can be greatly simplified since the goal has been stated up front of what needed to have achieved. Returning momentarily to the isometrically projected cube illustration above, if an isometrically projected cube does not the result from execution of the declarative declaration then the testing has yielded a problem that needs to be rectified. If on the other hand an isometrically projected cube is resultant, then verification of the result is instantaneous as the result of execution of the declarative definition is what was actually required and what actually occurred.

Additionally, testing component 102 can include executor component 206. As will be appreciated by those moderately cognizant in this field of endeavor, there can be numerous paths that can be traversed through in an application or software program, and in an application interface (e.g., application user interface 104) in particular, in order to achieve a single testing scenario (e.g., context menus, mouse, keyboard, drag-drop functionalities, toolbox configurations, etc.). Each operation can represent a decision point which can create a fairly large number of permutations through the application or software 106 and/or through the application user interface 104. In accordance with an aspect, since the claimed subject matter separates the answer (e.g., the scenario) from execution (e.g., traversal through the numerous paths) of the answer, the claimed matter can utilize the answer to determine which of the paths to take in order to reach or effectuate the stated goal (e.g., the scenario). In order to accomplish actuation towards the answer (e.g., typically formulated as a declarative declaration) executor component 206 can be utilized. Executor component 206 can utilize the supplied declarative declarations that indicate the goal or answer that is to be achieved, and subsequently and/or contemporaneously verified in order to select one or more permissible or probable traversal paths that will satisfy the declaratively declared scenario. As will be appreciated, since there can be multiple disparate ways of traversing through the software or application to reach a particular goal scenario, executor component 206 can utilize numerous different executor types to effectuate the scenario goal. For instance, executor component 206 can utilize an executor optimized to traverse through the application utilizing only mouse clicks. As a further example, executor component 206 can employ an executor optimized to traverse through the software application interface in order to replicate a typical customer experience.

Additionally, testing component 102 can include differential component 208 that can compare the results of the executed product as actuated by executor component 206 with the answer specified in the declarative definition previously supplied, or more particularly, differential component 208 compares the results of the executed product (e.g., the product result) with the original answer (e.g., the answer specified in the declarative definition). The differences, if any, between the answer supplied in the declarative definition and the answer extracted from utilization of the application or software once executor component 206 has completed its peregrinations through application 106 can be termed “answer diffs”. The answer diffs so generated by differential component 208 can be persisted to one or more data stores and subsequently utilized both for verification purposes as well as for solving incremental operations as outlined below. Nevertheless, the claimed matter is not so limited, as incremental operations can be performed by saving off a previous answer and then identifying the differences between the previous answer and a new answer.

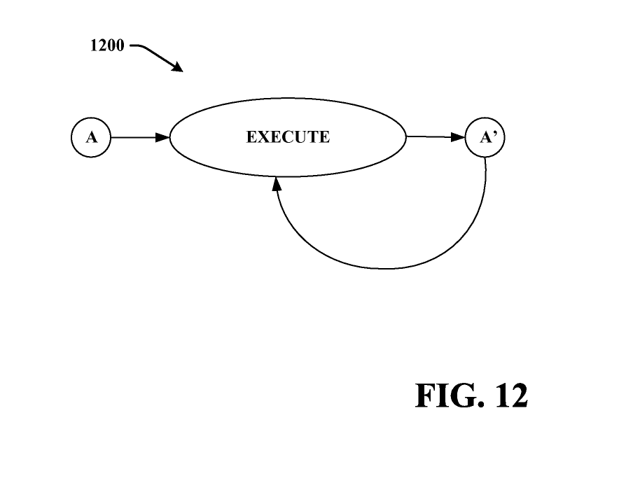

Moreover, testing component 102 can further include incremental component 210 that can utilize any answer diffs generated through utilization of differential component 208 to incrementally adjust to changing declarative declarations. For instance, a very common user scenario can be the following: load an existing file (e.g., from a data store, database, directory structure, memory, computer readable medium, and the like) and edit/modify the file in some manner in a designer application. Accordingly, the first answer A (e.g., the answer that one would expect in the file) can be declaratively described after which the declaratively defined answer can be executed by executor component 206 (e.g., executor component 206 can employ a load file executor aspect). The result of such execution by executor component 206 can be a second answer A′ that declaratively defines the expected answer resulting from execution of the load file executor aspect by executor component 206 once all modifications are complete. The second answer A′ can be subsequently utilized by incremental component 210 to cause executor component 206 to employ a second executor aspect (e.g., a designer executor aspect) utilizing the second declaratively defined answer A′. A state diagram 1200 outlining the foregoing is presented in FIG. 12.

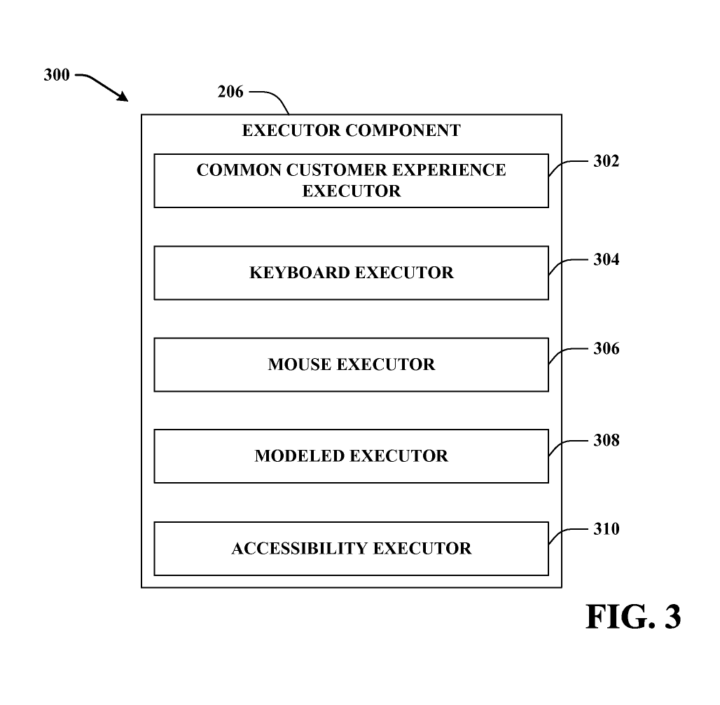

FIG. 3 provides further exemplification 300 of executor component 206 in accordance with an aspect of the claimed matter. While traversal through application 106 via utilization of application user interface 104 would typically take place through a human intermediary utilizing application 106 to perform some unit of work, in the context of the testing of application 106 and more particularly application user interface 104, traversal and/or thorough and extensive manipulation of application 106 through its associated application user interface 104 can be facilitated and/or effectuated via utilization of the claimed subject matter. Accordingly and as illustrated, executor component 206 can include a plurality of customized executors such as common customer experience executor 302 that can be used to effectuate traversal of application 106 via application user interface 104 as a common user would traverse through application 106 via its associated application user interface 104.

Further, executor component 206 can also include keyboard executor 304 that can be utilized, for example, to exercise features of application 106 and/or application user interface 104 that involve utilization of keyboard aspects of application 106 and/or application user interface 104, such as keyboard interaction (e.g., individual key strokes), key sequences (e.g., ALT+CTRL+DEL), utilization of keyboard function buttons, etc.

Additionally, executor component 206 can also include mouse executor 306 that can be used, for example, to exercise features of application 106 and/or application user interface 104 that involve utilization of mouse clicks features of application 106 and/or application user interface 104. Furthermore, executor component 206 can also include modeled executor 308 and accessibility executor 310. Modeled executor 308 can effectuate a random perambulation through various and disparate features of application 106 and/or application user interface 104. For instance, modeled executor 308 can randomly utilize one or more aspects from various other executors associated and/or included with executor component 206. For example, modeled executor 308 can use randomly selected features associated with keyboard executor 304, common customer experience executor 302, and/or mouse executor 306 in one or more manners uncommon to the normal functionality of the particular executor. To illustrate, modeled executor 308 can utilize aspects of mouse executor 306 to effectuate one or more key sequences (e.g., through mouse clicks) that would normally be exercised by keyboard executor 304, similarly, functionality typically attributable to mouse executor 306 can be effectuated by keyboard executor 304 through series of key sequences. To provide further illustration, modeled executor 308 can also employ aspects of accessibility executor 310 that typically tests features that are designed to improve the way accessibility aids work with applications and their associated interfaces (e.g., application 106 and application user interface 104) wherein accessibility aids can include screen readers for the visually impaired, visual indicators or captions for persons with hearing loss, software to compensate for motion disabilities, and the like. Thus, for instance, modeled executor 308 can utilize features associated with a set of keyboard sequences that would typically be manipulated and tested by key board executor 304, by instead testing to see whether the set of keyboard sequences are accessible through functionalities and/or features generally utilized to compensate those with motor deficits. Additionally and/or alternatively, modeled executor 308,where it is aware of the possible traversal graphs (e.g., of a state machine), can ensure that at the conclusion of its perambulation that it arrives at the resultant state

As will be appreciated by those of ordinary skill in this field of endeavor, other executor aspects can be included or associated with executor component 306. Moreover, as will be further appreciated, executor component 206 typically has full knowledge and is fully cognizant of the numerous paths through application 106 and/or the multiplicity of permissible and/or impermissible traversals through application user interface 104 in order to manipulate the underlying application and to effectuate and achieve a particular goal or direction. Thus, an executor associated with executor component 206 can be responsible for iterating through the answer outlined in the declarative definition and performing the imperative (logical) operations and thus can be viewed as a one to many transform from declarative to imperative space.

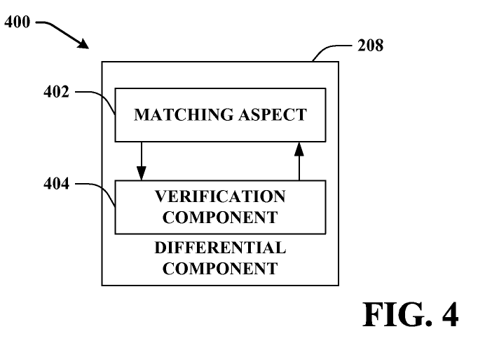

FIG. 4 provides further depiction 400 of an illustrative differential component 208 in accordance with an aspect of the claimed matter. As depicted differential component 208 can include matching aspect 402 that can utilize the declarative definition initially supplied or an answer diff previously generated to establish whether there are any differences between the answer provided in the declarative definition/answer diff previously supplied and/or generated with the answer extracted from utilization of one or more executor components on application 106 and/or application user interface 104. Where differences are ascertained an “answer diff” can be established and thereafter persisted or employed by one or more other executor components in testing application 106 and its associated application user interface 104.

Additionally, verification component 404 can be utilized to verify that the answer extracted from the execution of the declarative definition (e.g., results of the product under test) comports with the answer supplied in the declarative definition (e.g., the initial answer). Where there is a difference between the answer extracted from execution of the declarative definition and the answer supplied in the declarative definition, verification is still possible but merely indicates that there were problems with the product. If however, the answer extracted from execution of the declarative definition matches the answer indicated in the declarative definition are identical (e.g., through utilization of matching aspect 402), then verification component 404 can provide (e.g., output) indication of this equivalence.

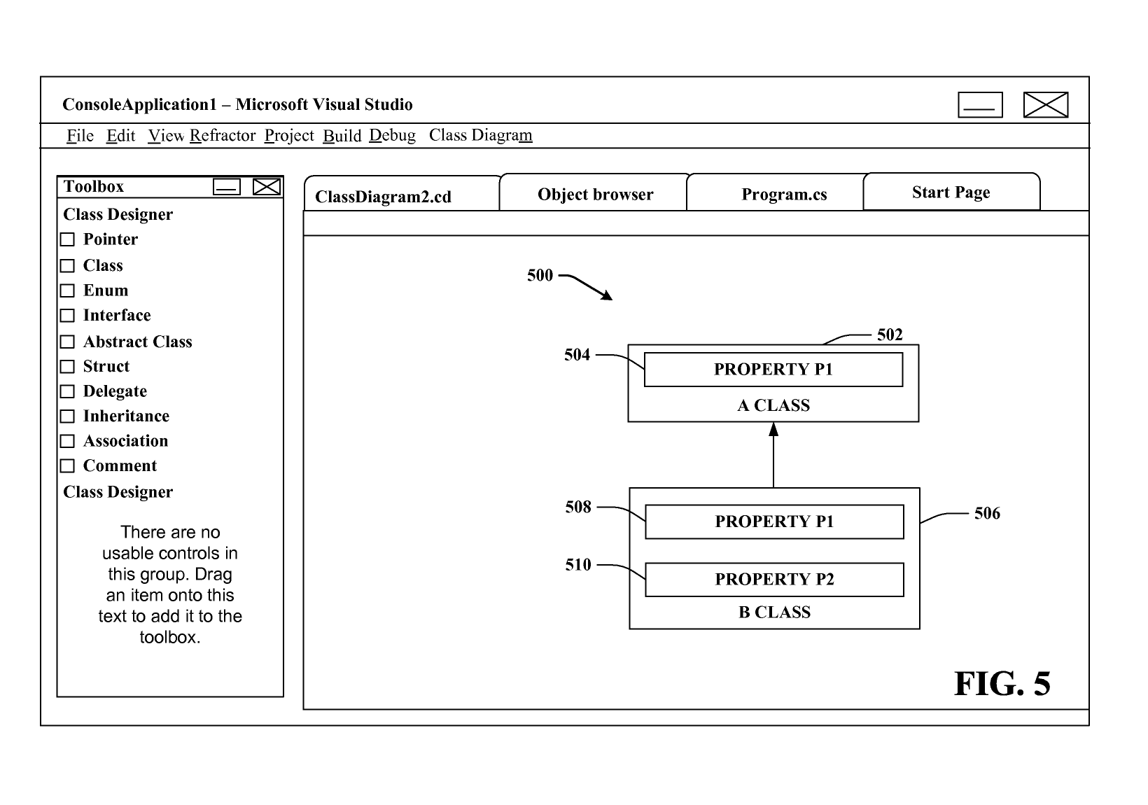

To provide further elucidation of the foregoing consider the following illustration as exemplified in FIGS. 5-7. Imagine being responsible for testing Microsoft Visual Studio's C Sharp Class Diagram user interface. In a nutshell it's a UI designer (canvas) that allows one to define programming types, visually (classes, properties, methods, inheritance, arguments, overrides, etc). It has many of the rich controls typically found in user interface's today; canvas surface, drag-drop toolbox, context menus, edit in place, layout managers, context sensitive property windows, etc.

Automation application programming interface (API) tools can help drastically with manipulating low-level primitive; buttons, menus, operations, drag items on the canvas, etc. Unfortunately for a typical user interface, there can be literally thousands of lines of code, even with the latest best-of-breed tools.

Instead today's user interface testers typically create ‘abstractions’ on top of low-level automation application programming interfaces (APIs). The abstractions reduce the lines of code and begin to customize the generic application programming interfaces (APIs) to something that feels natural and custom to that particular application. For example, suppose one needed to test inheritance (as shown in FIG. 5). Namely two classes A 502 and B 506, with a relationship between them wherein B class 506 inherits from A class 502, and A class 502 has property P1 504, B class 506 overrides P1 504 with P1 508, B class 506 also adds property P2 510 which can, for example, be of type string, and marked as virtual. Using today's tools one can exclude recorders and playback tools since they perform very little verification, tend to be laborious, and only cover one exact path of getting A class 502 and B class 506 onto the canvas. Rather one would probably leverage automation application programming interface (API) tools. Accordingly, if one took a managed code application programming interface that exposes user interface controls for test automation and assistive technology such screen readers (e.g. user interface automation (UIA)) plus a few hundred hours of development time, one could create a much simpler focused application programming interface (API) for the Class Designer. For example, to test the same (overly) simplistic (A inherits from B) scenario, one's code would look like a sequence of; OpenVSProject, CreateClassDiagram, AddClass, EditName, AddProperty, EditName, EditType, EditVirtual, AddClass, DragInheritnaceFromToolbox, AddProperty, EditName, EditOverrides, Edit Type, AddProperty, etc. Unfortunately however, despite this level of investment, one would have just reduced the lines of code; but not necessarily enriched the testing scenarios.

In order to move away from such a primitive state of affairs one needs to define the answer in terms of what needs to be accomplished in the user interface. The representation of the answer can be literally anything that makes sense for a particular domain space, although in this instance (abstract) trees lend themselves very well (to hierarchies of classes, properties, types). In the following code snippet, the answer can be defined (e.g., classes A and B) and all the details of inheritance, property names, types, etc. They can be defined in terms of an illustrative tree representation, and one will notice that it is exclusively focused on class A and class B, user interface primitives are not clouding, consuming, or taking away from the focus on the scenario.

```
public void Test1( )
{
var a = Class(“A”,
    Property(“P1”)
    ) ;
var b = Class(“B”,
    Base(a),
    Property(“P1”),
    Property(“P2”,
      Type(typeof(String))
      )
    ) ;
```

Once the answer is defined (as above) then it can be executed using the below code snippet.

//continued from Test1( )
ClassDiagram.Execute(a, b);
ClassDiagram.Verify(a, b);

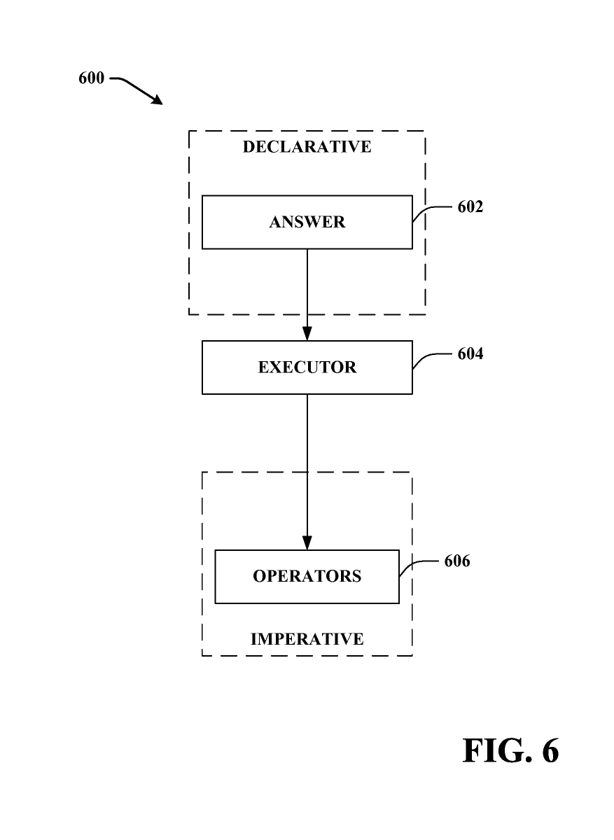

The executor can be responsible for taking the declarative answer and transforming it into the imperative user interface operations (see FIG. 6 item 606). For example, in this particular case, the answer is defined in terms of a tree (e.g., 602), so the executor 604 is simply a tree visitor (e.g., a tree visitor pattern). With a simple visitor method, it stops on each node it cares about, and performs the appropriate set of user interface operations to achieve that. For example, given a Class node it calls AddClass, EditName, and recurses into the children. For a property node it calls AddProperty, EditName, EditType, and recurses into its children, etc.

The verifier in the code snippet (above) simply traverses the user interface state (e.g., using existing automation application programming interface (API) calls) and extracts that state also into a tree. Then that tree is simply compared with the original answer tree for containment. This process can be termed “answer diffs”. Answer diffs can be considered the key to simplifying verification. The answer that was passed to execute, is the same answer that is used in verification. No state tracking, complex code, or re-implementing the development code, the expected answer was provided (or at least everything one cared about verifying).

Answer diffs can be the silver bullet to solving other traditionally difficult problems. For example, now that one has executed (a, b) and has verified it, assume that the aim now is to simulate performing a number of changes to that data (e.g., a common scenario for most customers). Assume that class C is added, inheriting from A as well, it has a new property P3, additionally assume that class B is changed to not override P1, add a new property P3, and edit P2 to be of type integer instead of a string.

Traditionally all the foregoing changes would have required a slew of imperative (primitive) calls to add, remove, and edit objects that are on the surface. Instead the claimed matter takes the simpler approach and distilling the answer in terms of what needs to be done, rather than all the steps needed to get there. Accordingly, the answer can be redefined as:

```
//continued from Test1( )
  ClassDiagram.Execute(a, b);
ClassDiagram.Verify(a, b);
  var b’ =  Class(“B”,
    Base(a),
      Property(“P2”,
        Type(typeof(int))
          )
      Property(“P3”)
          ) ;
  var c =  Class(“C”,
    Base(a),
    Property(“P3” )
    );
  ClassDiagram.Execute(a, b’, c);
  ClassDiagram.Verify(a, b’, c);
```

The executor then simply executes (a,b′,c). It does this by diffing the previous answer [in this case (a,b)] with (a,b′,c) and comes up with a set of differences (nodes). It visits (same tree visitor as previously) each node and performs the appropriate operation (e.g., AddClass, AddPropety, DeleteProperty, EditType, etc). In fact all executions (either the first one or iterative) are all done with answer diffs, the first one is just (null, null)−(a,b), so everything looks like additions (that need to be executed on the surface).

The separation of the scenario (answer) from the execution (user interface operations), also helps address the (age old) problem of numerous paths in the product to the same answer. By separating the answer from the execution, one could have different executors that are optimized towards different parts of the user interface (e.g., mouse, keyboard, context menus, drag-drop, etc). One could even have random or model-based executors, to cover a vast majority of the infinite problem space.

In addition, this same separation allows one to have the same answer, for different user interface contexts. Today's user interfaces are famous for customization, having numerous different presentation views (e.g., list views, explorer trees, grid view, outline views, canvases, etc). Each context (view) exposes a slightly different set of the data, with differences in behavior (e.g., granularity, read-only, etc). Traditionally these would have been unique cases; add (A,B) to the canvas, add (A,B) to the code view, add (A,B) to an existing file then load it, etc.

Instead all of those are just separate executors. Using the above example of the Class diagram and its 3 views (canvas, code, load), our executors are simply; canvas=diagram executor, code=C Sharp executor, load=file executor, etc. The scenario remains the same, so the focus remains on the richness of the scenario, and the imperative differences of the countless contexts in the user interface do not complicate, multiple, or defocus the scenario.

```
//Execute on the diagram
  ClassDiagram.Execute(a, b’, c);
//Execute on the code directly
  CSharpView.Execute(a, b’, c);
//Execute on the code directly
  ClassDiagramFile.Execute(a, b’, c);
//etc...
```

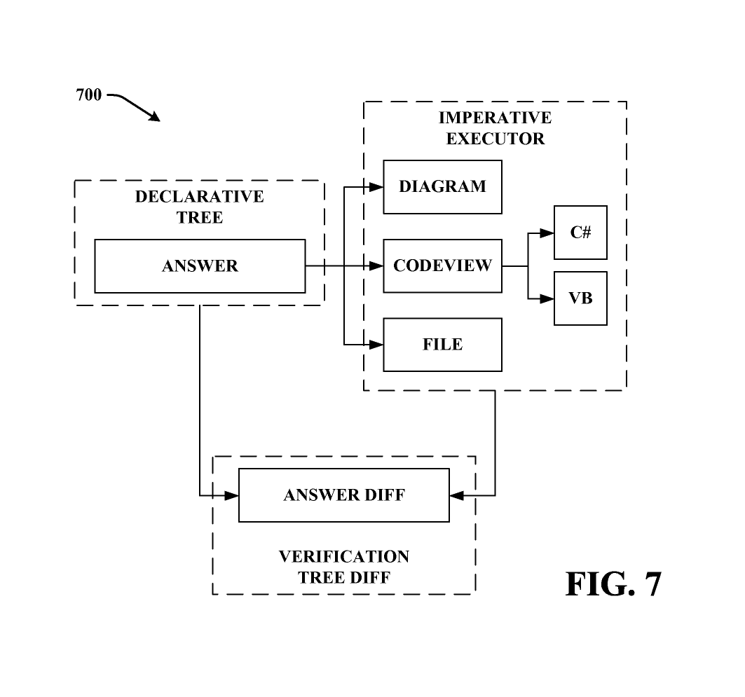

FIG. 7 provides illustration 700 of foregoing in a diagram applying the same answer to numerous execution paths

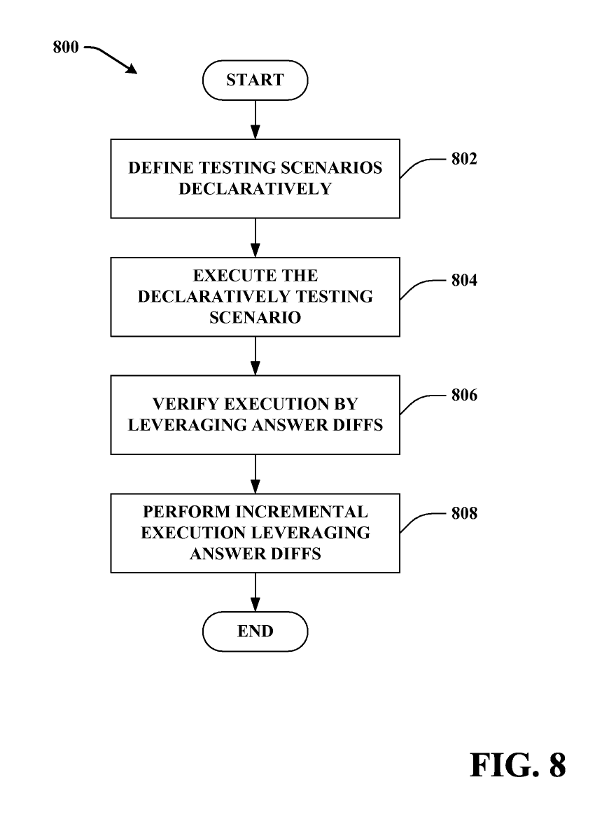

In view of the illustrative systems shown and described supra, methodologies that may be implemented in accordance with the disclosed subject matter will be better appreciated with reference to the flow chart of FIG. 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 8 illustrates a machine implemented methodology 800 that facilitates and/or effectuates declarative testing of software applications and/or software application interfaces in accordance with an aspect of the claimed subject matter. Method 800 can commence at 802 where a testing scenario can be declaratively defined wherein only the answer (or intent), rather than all the intricate acts needed to accomplish the answer, of the scenario is captured. At 804 the declaratively defined testing scenario can be executed at 804 by one or more executors. At 806 the answer extracted as a consequence of the execution of the declaratively defined testing scenario can be compared with the answer specified as a consequence of the declaratively defined testing scenario to ascertain whether the answer extracted as a consequence of the execution of the declaratively defined testing scenario and the answer specified as a consequence of the declaratively defined testing scenario are the same or similar. At 808 where any differences (e.g., answer diffs) are noted as a consequence of act 806 these differences can be incrementally executed by the one or more disparate executors, after which method 800 can terminate.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

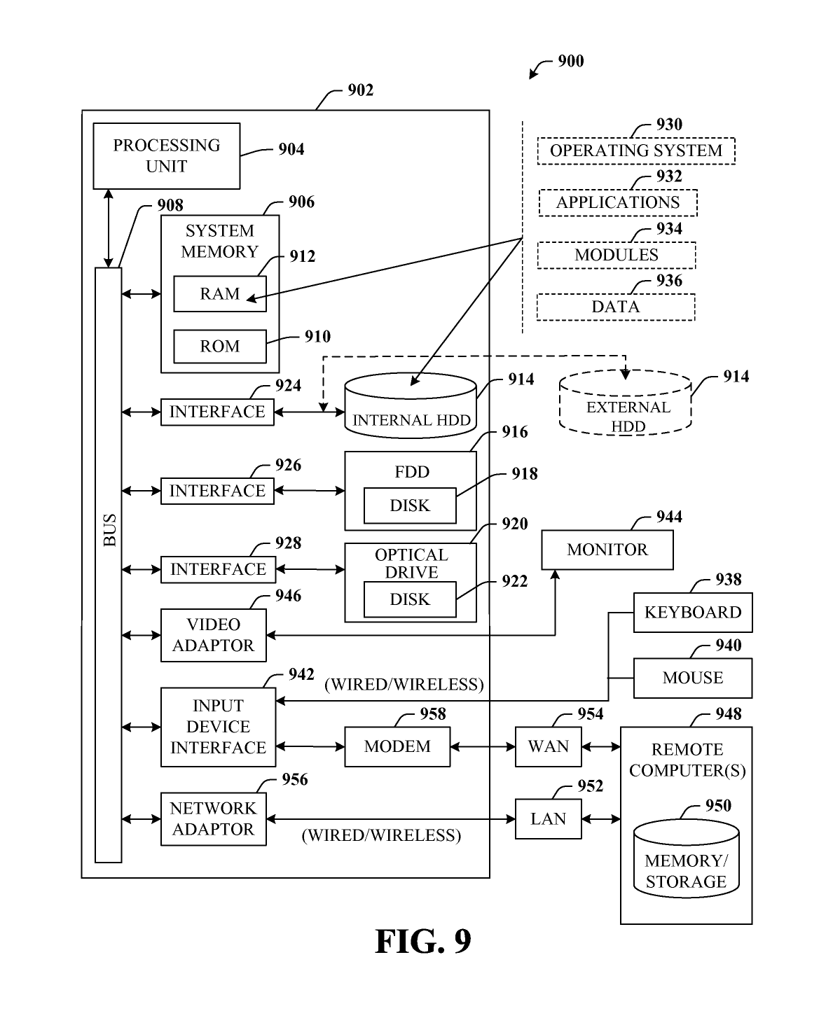

Referring now to FIG. 9, there is illustrated a block diagram of a computer operable to execute the disclosed system. In order to provide additional context for various aspects thereof, FIG. 9 and the following discussion are intended to provide a brief, general description of a suitable computing environment 900 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the illustrative environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that the claimed subject matter can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1094 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are illustrative and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

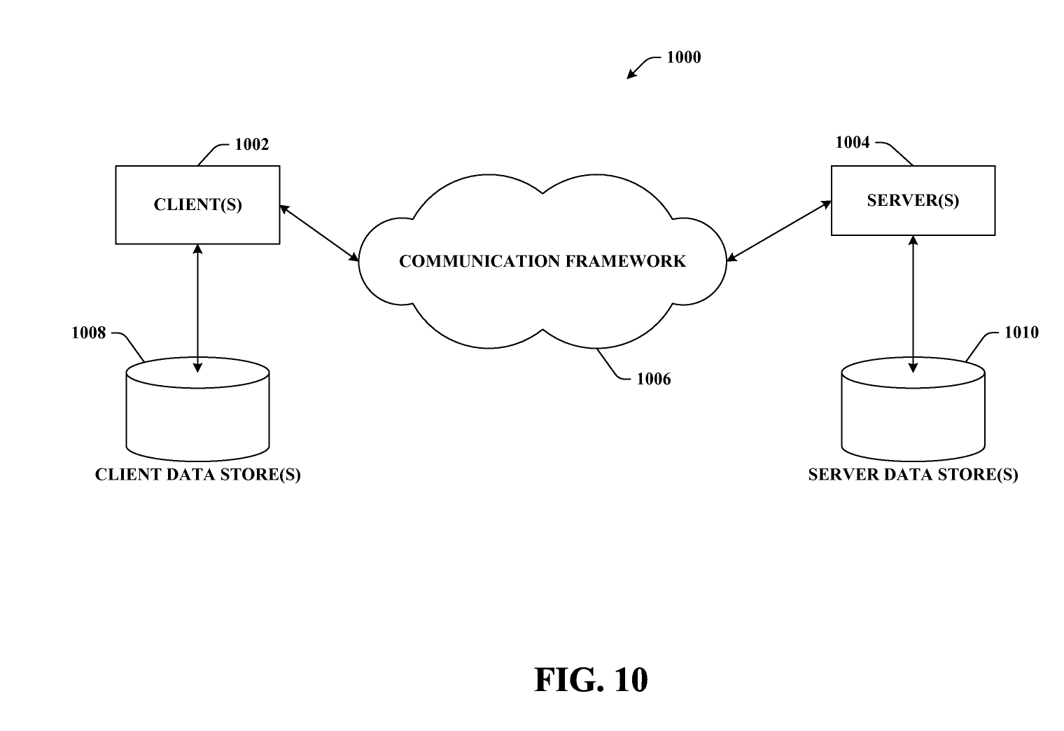

Referring now to FIG. 10, there is illustrated a schematic block diagram of an illustrative computing environment 1000 for processing the disclosed architecture in accordance with another aspect. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that effectuates declarative testing of a software application, comprising:
an interface component that receives a declarative definition of a testing scenario where the declarative definition of the testing scenario is one ultimate answer to the testing scenario;
an executor component that utilizes the declarative definition of the testing scenario to exhaustively test the software application; and
a differential component that compares the declarative definition of the testing scenario with a result of the exhaustive test of the software application, where the differential component determines that the comparative definition of the testing scenario and the result of the exhaustive test of the software application is dissimilar, the differential component persists a difference between the comparative definition of the testing scenario and the result of the exhaustive test of the software application to a storage component as an answer diff.

2. The system of claim 1, the declarative definition of the testing scenario focuses on an aspirational outcome of the testing scenario.

3. The system of claim 1, the executor component employs at least one executor to test the software application, the at least one executor includes one or more of a modeled executor, a common customer experience executor, a keyboard utilization executor, an accessibility executor, a mouse utilization executor, or an executor that receives the declarative definition of the testing scenario and produces one or more imperative operations.

4. The system of claim 3, the at least one executor optimized to at least one of employ a different path, utilize a different starting point, or a different view of the software application.

5. The system of claim 3, the modeled executor utilizes one or more feature associated with at least one of more of the common customer experience executor, the keyboard utilization executor, the accessibility executor, or the mouse utilization executor in a manner uncommon to the functionality of the at least one of more of the common customer experience executor, the keyboard utilization executor, the accessibility executor, or the mouse utilization executor.

6. The system of claim 3, the executor component has full cognition of the software application under test, where full cognition of the software application includes knowledge of a plurality of pathways necessary to attain an outcome provided in the declarative definition of the testing scenario

7. The system of claim 3, the executor component based at least in part in the full cognition of the software application under test autonomously ascertains at least one of a permissible path or an impermissible path through the software application in order to attain a goal included in the declarative definition of the testing scenario.

8. The system of claim 3, further comprising an incremental component that utilizes the answer diff to cause the executor component to actuate an executor other than the executor utilized to generate the answer diff.

9. The system of claim 1, the software application includes a plurality of views of similar data that include at least one of tree controls, list views, or designer canvases, each of the plurality of views is associated with a unique behavior or a subset of operations and associated data.

10. The system of claim 1, the software application includes a plurality of starting points, each of the plurality of starting points utilized by at least the incremental component or the executor component to effectuate the result of the exhaustive test of the software application.

11. A machine implemented method that effectuates declarative testing of a software application, comprising:
obtaining a declarative definition of a testing scenario in terms of an answer;
employing the declarative definition to test the software application; and
comparing the declarative definition with a result of the employing to generate an answer diff.

12. The method of claim 11, the comparing further comprising determining that the declarative definition and the result of the employing are disparate, based at least in part on the determining storing a difference between the declarative definition and the result of the employing.

13. The method of claim 11, the employing further comprising an executor to test the software application, the executor includes heterogeneous functionalities that leverages one or disparate executor behavior associated with the software application.

14. The method of claim 13, the executor optimized to at least one of employ a disparate path, employ a disparate starting point, or employ a disparate view associated with the software application under test.

15. The method of claim 13, the executor optimized to have full knowledge of the software application under test.

16. The method of claim 15, the executor automatically selects one or more paths to traverse in order to achieve a target included in the declarative definition.

17. The method of claim 11, further comprising incrementally utilizing a difference elicited by the comparing to actuate the employing to iterate to a target included in the declarative definition.

18. A machine readable medium having stored thereon machine executable instructions for:
soliciting a declarative definition of a testing scenario;
utilizing the declarative definition to test the software application; and
comparing the declarative definition with a result of the employing to generate an answer diff.

19. The machine readable medium of claim 18, wherein the comparing further comprising determining that the declarative definition and the result of the employing are disparate, based at least in part on the determining storing a difference between the declarative definition and the result of the employing.

20. The machine readable medium of claim 18, wherein the employing further comprising an executor to test the software application, the executor includes heterogeneous functionalities associated with the software application.
